(19) United States
(12) Patent Application Publication
(10) Pub. No.: US 2017/0132488 A1
(43) Pub. Date: May 11, 2017

(54) IMAGE DISPLAY APPARATUS, IMAGE DISPLAY CONTROL APPARATUS, AND IMAGE DISPLAY METHOD

(71) Applicant: CANON KABUSHIKI KAISHA, Tokyo (JP)

(72) Inventor: Tomoya Asanuma, Kawasaki-shi (JP)

(21) Appl. No.: 15/342,670

(22) Filed: Nov. 3, 2016

(30) Foreign Application Priority Data
Nov. 6, 2015 (JP) 2015-218784

(51) Int. Cl. G06K 9/46; G06T 5/00; G06T 7/00; G09G 5/10

(52) U.S. Cl. CPC G06K 9/4671; G06K 9/4661; G09G 5/10; G06T 5/00; G06T 7/0012; G09G 2320/062; G06K 2009/4666; G06T 2207/30004

(57) ABSTRACT

An image display apparatus includes a display unit, a backlight, a diagnosis target region acquisition unit, and a backlight control unit. The display unit displays an image. The backlight changes the light emission luminance in at least a part of a region where the display unit displays the image. The diagnosis target region acquisition unit acquires data of an interest region in the image. The backlight control unit reduces a light emission luminance value of the backlight corresponding to a second region, which is a partial image region that excludes a first region including at least the interest region.

### BACKGROUND OF THE INVENTION

Field of the Invention

The aspect of the embodiments relates to an image display apparatus, an image display control apparatus, and an image display method.

Description of the Related Art

As discussed in Japanese Patent Application Laid-Open No. 2011-115264, there is a conventional technique capable of enabling a user (e.g., a physician) to designate an interest region in a medical image and displaying the medical image with a highlighted interest region by masking a region other than the interest region at a predetermined luminance that is lower than the luminance of pixels in the interest region.

In general, if a display apparatus (e.g., a liquid crystal device) is configured to control a luminance value of an image by transmitting the light emitted from a light emission unit, “black floating ” may occur due to the influence of the light emission unit even when the luminance values of pixels constituting the image are reduced. In such a case, the black floating caused by the region other than the interest region may interfere with user's (e.g., physician's) observation on the interest region.

### SUMMARY OF THE INVENTION

An image display apparatus according to the aspect of the embodiments includes a display unit configured to display an image, a light emission unit configured to change light emission luminance in at least a partial region of a region where the display unit displays the image, a region acquisition unit configured to acquire data to identify an interest region in the image, and a control unit configured to reduce a light emission luminance value of the light emission unit corresponding to a second region, which is an image region excluding a first region that includes at least the interest region.

An image display method according to the aspect of the embodiments causes a processor to perform processing for acquiring data to identify an interest region in an image displayed by an image display unit configured to control light emission luminance, acquiring a second region, which is an image region excluding a first region that includes at least the interest region, and causing the image display unit to reduce the light emission luminance of a region corresponding to the second region.

An image display control apparatus according to the aspect of the embodiments controls a light emission unit configured to control light emission luminance in at least a partial region of a region where the display unit displays an image. The image display control apparatus includes a region acquisition unit configured to acquire data to identify an interest region in the image, and a control unit configured to reduce a luminance value of the light emission unit corresponding to a second region, which is an image region excluding a first region that includes at least the interest region.

Another mode of the aspect of the embodiments is a program that causes a computer to realize each step of the above-mentioned method. The program may be provided as a part of a firmware incorporated in a device to perform a basic control for a hardware resource (e.g., a calculator or a display apparatus). The firmware can be stored, for example, in an appropriate semiconductor memory, such as a read only memory (ROM) or a flash memory, of the device. To provide the firmware or to update a part of the firmware, a computer-readable nonvolatile storage medium storing the above-mentioned program may be provided. Further, the above-mentioned program may be transmitted via an appropriate communication line.

Further features of the aspect of the embodiments will become apparent from the following description of exemplary embodiments with reference to the attached drawings.

### BRIEF DESCRIPTION OF THE DRAWINGS

FIG. 1 schematically illustrates an appearance of an image display system according to a first exemplary embodiment.

FIG. 2 schematically illustrates a functional configuration of the image display system according to the first exemplary embodiment.

FIG. 3A is a first view illustrating a diagnosis target region designation function and an enlarged display function that can be realized by a diagnosis target region acquisition unit.

FIG. 3B is a second view illustrating the diagnosis target region designation function and the enlarged display function that can be realized by the diagnosis target region acquisition unit.

FIG. 3C is a third view illustrating the diagnosis target region designation function and the enlarged display function that can be realized by the diagnosis target region acquisition unit.

FIG. 4 schematically illustrates backlight emission regions, each serving as a processing target of a backlight control unit.

FIG. 5 illustrates backlight emission luminance adjustment processing that can be realized by the backlight control unit.

FIG. 6A is a first view illustrating a backlight emission region that has an adverse influence on the luminance of an image region identified based on interest region coordinate information.

FIG. 6B is a second view illustrating a backlight emission region that has an adverse influence on the luminance of an image region identified based on the interest region coordinate information.

FIG. 7 illustrates luminance adjustment that can be performed by the backlight control unit.

FIG. 8 is a flowchart illustrating a flow of backlight adjustment processing that can be performed by the image display system according to the first exemplary embodiment.

FIG. 9 is a flowchart illustrating a flow of interest region acquisition processing that can be performed by an image display control apparatus according to the first exemplary embodiment.

FIG. 10 is a flowchart illustrating a flow of interest region coordinate information reception processing that can be performed by an image display apparatus according to the first exemplary embodiment.

FIG. 11 is a flowchart illustrating a flow of luminance value suppression processing that can be performed by the image display apparatus according to the first exemplary embodiment.

FIG. 12 schematically illustrates a functional configuration of an image display system according to a second exemplary embodiment.

FIG. 13 is a flowchart illustrating a flow of backlight adjustment processing that can be performed by the image display system according to the second exemplary embodiment.

FIG. 14 schematically illustrates a functional configuration of an image display system according to a third exemplary embodiment.

FIG. 15 is a flowchart illustrating a flow of backlight adjustment processing that can be performed by the image display system according to the third exemplary embodiment.

FIG. 16A is a first view illustrating luminance adjustment for changing the luminance according to various conditional changes in the enlarged display function of a viewer.

FIG. 16B is a second view illustrating luminance adjustment for changing the luminance according to various conditional changes in the enlarged display function of the viewer.

FIG. 16C is a third view illustrating luminance adjustment for changing the luminance according to various conditional changes in the enlarged display function of the viewer.

FIG. 17A is a first view illustrating various display patterns of the viewer.

FIG. 17B is a second view illustrating various display patterns of the viewer.

FIG. 17C is a third view illustrating various display patterns of the viewer.

FIG. 18A is a first view illustrating a relationship between a change of information relating to pixels included in an interest region and a luminance value of a region other than the interest region.

FIG. 18B is a second view illustrating a relationship between a change of the information relating to the pixels included in the interest region and a luminance value of the region other than the interest region.

FIG. 18C is a third view illustrating a relationship between a change of the information relating to the pixels included in the interest region and a luminance value of the region other than the interest region.

FIG. 19A is a fourth view illustrating a relationship between a change of the information relating to the pixels included in the interest region and a luminance value of the region other than the interest region.

FIG. 19B is a fifth view illustrating a relationship between a change of the information relating to the pixels included in the interest region and a luminance value of the region other than the interest region.

FIG. 19C is a sixth view illustrating a relationship between a change of the information relating to the pixels included in the interest region and a luminance value of the region other than the interest region.

### DESCRIPTION OF THE EMBODIMENTS

[Image Display System]

An image display system according to a first exemplary embodiment of the present invention causes an image display apparatus, which includes a light emission member capable of emitting image display light, to display a medical image. The image display apparatus accepts an instruction designating an interest region (Region-Of-Interest: ROI) in the medical image displayed by the image display apparatus from a physician or other user (hereinafter, simply referred to as “user”). The image display system controls light emission luminance of the light emission member included in the image display apparatus in such a way as to reduce a luminance value of a region other than the interest region in the medical image. According to the image display system according to the first exemplary embodiment, image reading efficiency can be improved because the user can concentrate diagnostic ability on the interest region. Further, the image display system can prevent black floating from occurring in the region other than the interest region.

More specifically, the image display system according to the first exemplary embodiment can be realized by using a work station, a personal computer (PC), or a tablet PC, which is capable of executing a medical image display viewer application (hereinafter, simply referred to as “viewer”) and is associated with a display unit (e.g., a liquid crystal monitor). If the user operates the viewer to designate an interest region (i.e., an observation target) on a displayed image, the image display apparatus reduces the light emission luminance of a backlight in a region that does not include the interest region. Accordingly, it becomes feasible to prevent light emission in the region other than the interest region from interfering with user's diagnostic observation. Further, electric power consumption in the image display apparatus can be reduced.

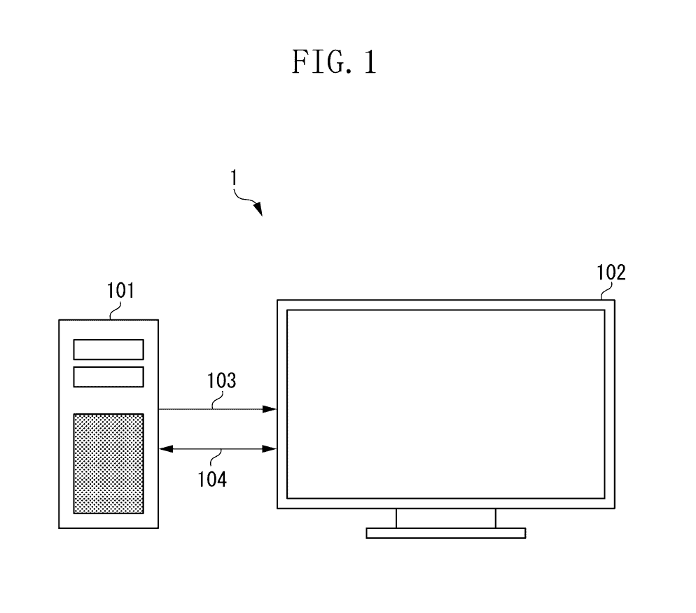

FIG. 1 schematically illustrates an appearance of an image display system 1 according to a first exemplary embodiment. The image display system 1 includes an image display control apparatus 101 and an image display apparatus 102. The image display apparatus 102 can display an image to be observed by a user of the image display system 1. The image display apparatus 102 includes a light emission unit that can change the light emission luminance, at least, at a partial region of an image display region. In the following description, the image display apparatus 102 is a liquid crystal display device. However, the image display apparatus 102 can be any other display apparatus that is equipped with a backlight. For example, the image display apparatus 102 can be a display apparatus including a micro electro mechanical systems (MEMS) shutter-type display panel.

The image display control apparatus 101 can output data of an image to be observed by the user to the image display apparatus 102 and can output information to control the light emission luminance of the backlight associated with the image display apparatus 102. A video cable 103 is a cable connecting the image display control apparatus 101 to the image display apparatus 102. The video cable 103 is, for example, a Display Port cable. A communication cable 104 connects the image display control apparatus 101 and the image display apparatus 102. The communication cable 104 is a cable capable of transmitting and receiving various data between the image display control apparatus 101 and the image display apparatus 102. The communication cable 104 is, for example, a universal serial bus (USB) cable.

[Functional Configuration of Image Display System]

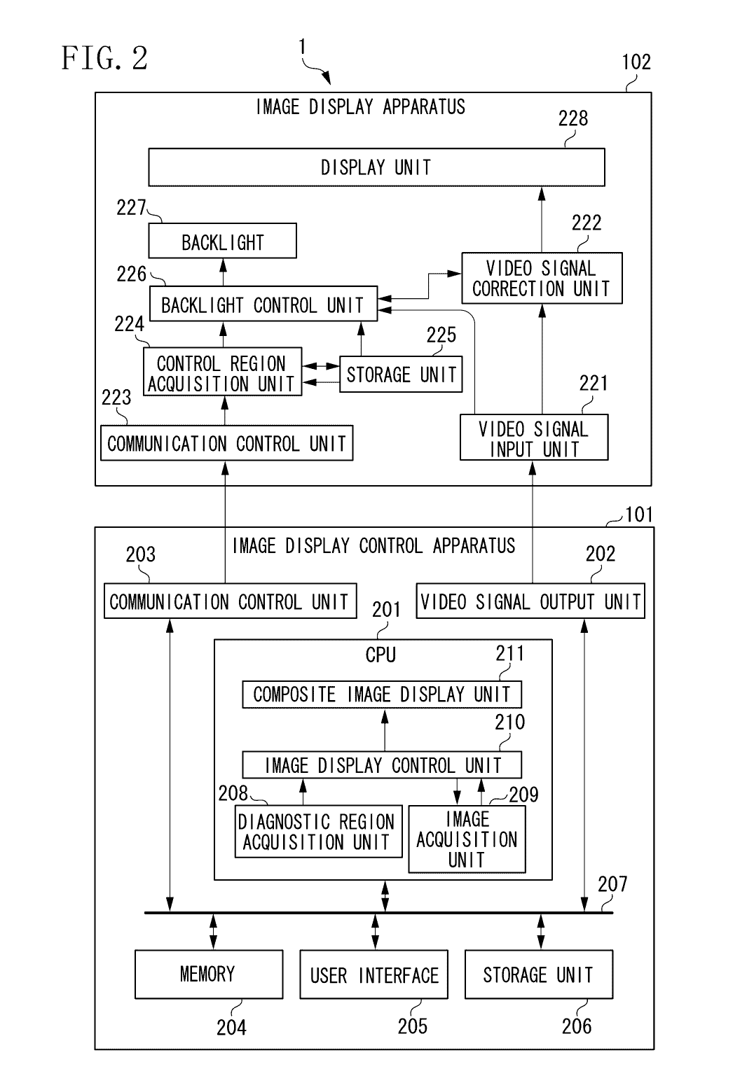

FIG. 2 schematically illustrates a functional configuration of the image display system 1 according to the first exemplary embodiment. The image display control apparatus 101 includes a central processing unit (CPU) 201, a video signal output unit 202, a communication control unit 203, a memory 204, a user interface 205, a storage unit 206, and an internal bus 207. The image display apparatus 102 includes a video signal input unit 221, a video signal correction unit 222, a communication control unit 223, a control region acquisition unit 224, a storage unit 225, a backlight control unit 226, a backlight 227, and a display unit 228.

The CPU 201 can control each functional unit provided in the image display control apparatus 101 by executing an operating system (OS) loaded into the memory 204 from the storage unit 206. Further, the CPU 201 can execute various applications (including the viewer). The video signal output unit 202 can output a video signal to the image display apparatus 102 via the video cable 103 illustrated in FIG. 1. The communication control unit 203 can control transmission/reception of various data between the image display apparatus 102 and the image display control apparatus 101.

The memory 204 can temporarily stores various data to be used in the image display control apparatus 101. For example, the data temporarily stored in the memory 204 includes video signals to be output from the image display control apparatus 101 to the image display apparatus 102 and data to be used when the CPU 201 executes various applications. The user interface 205 can accept a user's operational instruction input to the image display control apparatus 101. The user interface 205 can be constituted, for example, by a combination of a mouse and a keyboard. The storage unit 206 can store the OS, various applications, and data to be used in the applications. The storage unit 206 can be constituted, for example, by a nonvolatile memory, such as a hard disk drive or a Solid State Drive (SSD). The internal bus 207 is a transmission bus via which data can be transmitted and received between blocks in the image display control apparatus 101.

Hereinafter, the image display apparatus 102 will be described in detail below.

The video signal input unit 221 can acquire a video signal transmitted from the image display control apparatus 101. The video signal correction unit 222 can convert the video signal acquired from the video signal input unit 221 into a signal that can be displayed by the display unit 228. The backlight control unit 226 can adjust the light emission luminance of the backlight 227 based on the video signal acquired from the video signal input unit 221. The display unit 228 according to the first exemplary embodiment is a liquid crystal display panel, which includes a plurality of pixels. The display unit 228 can display an image based on the video signal acquired from the video signal correction unit 222. The backlight 227 includes a plurality of light emission units (e.g., light emission elements). The backlight 227 is functionally operable as a light source capable of reproducing an image on the display unit 228. The backlight 227 irradiates the display unit 228 with light emitted from the plurality of light emission units. The backlight 227 is, for example, constituted by a plurality of light emitting diodes (LEDs). However, the light source is not limited to the above-mentioned LED type. As another example, an organic electroluminescence (EL) type light source capable of controlling the luminance is employable.

The backlight control unit 226 can control the light emission luminance of the backlight, for each predetermined backlight emission region, based on the video signal acquired from the video signal input unit 221. The video signal correction unit 222 can correct the video signal based on the backlight luminance value determined by the backlight control unit 226. The communication control unit 223 can transmit and receive information to and from the communication control unit 203 of the image display control apparatus 101 via the communication cable 104. The control region acquisition unit 224 and the storage unit 225 will be described below together with the detailed backlight control unit 226 and video signal correction unit 222.

Next, various functions that can be realized when the CPU 201 executes related programs will be described in detail below. The CPU 201 can realize, by executing the related programs, a diagnosis target region acquisition unit 208 configured to provide a diagnosis target region acquisition function, an image acquisition unit 209 configured to provide an image acquisition function, an image display control unit 210 configured to provide an image display control function, and a composite image display unit 211 configured to provide a composite image display function.

The image display control unit 210 can perform entire image display control processing, which starts with acquisition of an image and ends with display of the acquired image. The image display control unit 210 can perform an operation based on a user instruction acquired via the user interface 205. The image display control unit 210 is, for example, the above-mentioned viewer.

The image acquisition unit 209 can acquire a medical image from the storage unit 206 according to an instruction from the image display control unit 210. In the present exemplary embodiment, the “medical image” is an image captured by an appropriate medical device. In particular, an image captured by an X-ray apparatus, an image relating to Magnetic Resonance Imaging (MRI) or any other nuclear magnetic resonance, and a relevant processed image are practical examples of the medical image. The medical images are compliant with Digital Imaging and Communication in Medicine (DICOM) standards, and include information about medical image formats that can be used by various inspection apparatus and protocols applied to communications between inspection devices.

The diagnosis target region acquisition unit 208 can acquire an interest region designated by a user via the user interface 205 from the medical image acquired by the image acquisition unit 209. In this respect, the diagnosis target region acquisition unit 208 is functionally operable as a region acquisition unit configured to accept a user instruction that designates an interest region in a medical image. The diagnosis target region acquisition unit 208 can be realized, for example, as a region designation function of the viewer. The diagnosis target region acquisition unit 208 can perform various image processing, such as enlarged display processing, windowing processing, and black/white reversing processing, on the medical image in the interest region.

The diagnosis target region acquisition unit 208 can output the information to identify the interest region to the composite image display unit 211 via the image display control unit 210. The composite image display unit 211 can display a predetermined shape (e.g., a rectangular shape) that indicates the interest region, so that the interest region of the image can be surely recognized by the user.

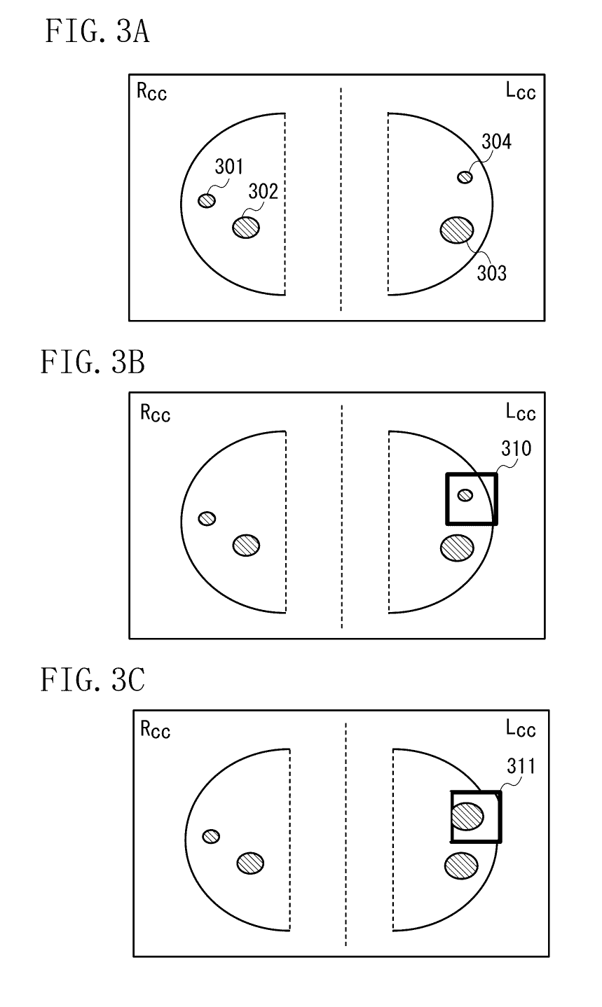

Each of FIGS. 3A to 3C illustrates a diagnosis target region designation function and an enlarged display function that can be realized by the diagnosis target region acquisition unit 208. More specifically, FIG. 3A illustrates exemplary mammography images of a left bust and a right bust arranged sequentially in a Cranio-Caudal (CC) direction, which is displayed on a screen of the display unit 228. In FIG. 3A, regions indicated by reference numerals 301, 302, 303, and 304 are lesion portions or suspicious lesion portions (i.e., user's observation target regions). The above-mentioned lesion or suspicious lesion portions can be checked by a physician or any other medical practitioner by looking or can be automatically detected by using a well-known mammography Computer-Aided Diagnosis (CAD).

FIG. 3B illustrates an exemplary method employable when a user designates an interest region 310. When the user observes a specific region (i.e., one of a plurality of regions), the user designates a region including the observation target via the user interface 205. According to the exemplary screen illustrated in FIG. 3B, a rectangle indicated by the reference numeral 310 is the interest region 310 that includes the target portion to be observed by the user. Although the interest region 310 illustrated in FIG. 3B has a rectangular shape, the shape designating the region is not limited to the rectangle.

FIG. 3C illustrates an exemplary processing result of enlargement processing that can be performed by the diagnosis target region acquisition unit 208. The diagnosis target region acquisition unit 208 performs the enlargement processing on the interest region 310 having been designated by the user. The diagnosis target region acquisition unit 208 expands the interest region 310 designated by the user with an expansion rate acquired from the user via the user interface 205. The diagnosis target region acquisition unit 208 can use a well-known image processing technique (e.g. spline interpolation) to realize the enlargement processing.

In FIG. 3C, a rectangle indicated by a reference numeral 311 is an enlarged interest region, which can be obtained by expanding the interest region 310 illustrated in FIG. 3B. The user can operate a dedicated controller of the user interface 205 to designate the expansion rate. Alternatively, the user can operate a graphical user interface (GUI) provided for the viewer to designate the expansion rate. As illustrated in FIGS. 3A, 3B, and 3C, when the user designates the interest region 310 together with a desired expansion rate, the diagnosis target region acquisition unit 208 realizes the enlarged display function for the designated interest region 310.

[Backlight Emission Luminance Adjustment]

In the image display system 1 according to the first exemplary embodiment, the backlight control unit 226 segments the backlight 227 into a plurality of backlight emission regions. The backlight control unit 226 performs local dimming processing for controlling the light emission luminance of the backlight for each segmented backlight emission region.

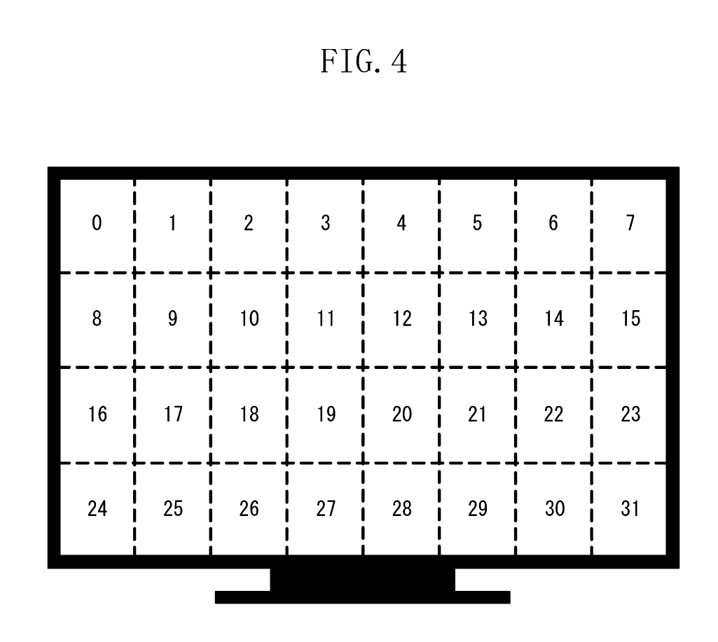

FIG. 4 schematically illustrates the backlight emission regions, each of which serves as a region to be subjected to the processing performed by the backlight control unit 226. In FIG. 4, reference numerals 0 to 31 indicate individual backlight emission regions. In other words, there are 32 backlight emission regions. The backlight control unit 226 adjusts the light emission luminance of the backlight for each backlight emission region, based on the video signal acquired from the video signal input unit 221. Hereinafter, backlight emission luminance adjustment processing that can be performed by the backlight control unit 226 will be described in detail below.

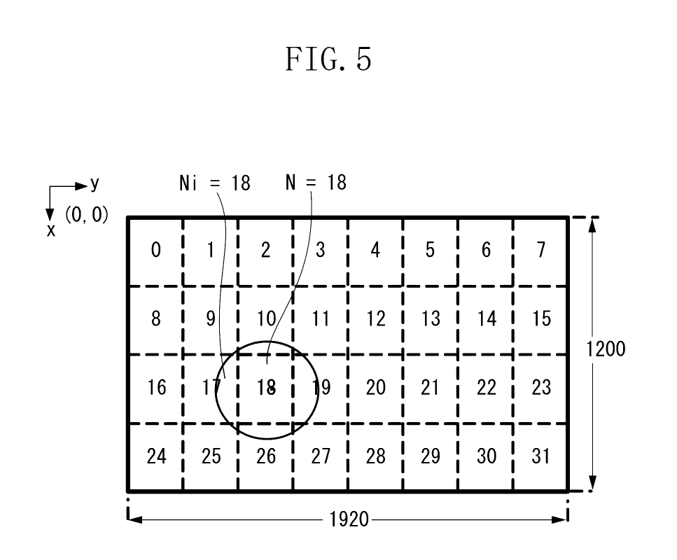

FIG. 5 illustrates the backlight emission luminance adjustment processing that can be performed by the backlight control unit 226. Similar to FIG. 4, reference numerals 0 to 31 in FIG. 5 indicate respective backlight emission regions. The control region acquisition unit 224 can acquire backlight emission region information from the storage unit 206. In the present exemplary embodiment, the “backlight emission region information” is information including coordinate information to identify each backlight emission region and information indicating a range where the light emission of the backlight has an adverse influence (hereinafter, referred to as “backlight emission influence region”) in each backlight emission region. In other words, the backlight emission region information is information indicating light emission characteristics of the display unit 228. The backlight emission region information can be measured beforehand by a manufacturer and can be stored in the storage unit 225, for example, in a manufacturing or shipping operation for the image display apparatus 102.

According to the example illustrated in FIG. 5, the display resolution of the display unit 228 of the image display apparatus 102 is 1920 pixels in the horizontal direction and 1200 pixels in the vertical direction. In FIG. 5, the coordinate information about the 18^{th} backlight emission region (N=18) is (x, y, w, h)=(480, 600, 240, 300). In the present exemplary embodiment, “x” represents an x-coordinate value of the display unit 228, “y” represents a y-coordinate value of the display unit 228, “w” represents the number of pixels arrayed in the horizontal direction to constitute the backlight emission region, and “h” represents the number of pixels arrayed in the vertical direction to constitute the backlight emission region. Further, each of the x-coordinate value and the y-coordinate value can be defined as the number of pixels sequentially arranged from the origin of the display unit 228.

In FIG. 5, the 18^{th} backlight emission influence region (Ni=18) having a circular shape is an example of the range where the light emission of the backlight emission region has an adverse influence. For example, the display unit 228 according to the first exemplary embodiment is configured to include a single LED disposed at the center of each backlight emission region. Light emitted from each LED diffuses in such a way as to form the backlight emission region. This is the reason why the shape of the backlight emission influence region is circular. Therefore, the backlight emission region does not necessarily coincide with the backlight emission influence region.

The control region acquisition unit 224 periodically acquires coordinate data to identify the interest region 310 in the image (hereinafter, referred to as “interest region coordinate information”) from the image display control apparatus 101 via the communication control unit 223. The control region acquisition unit 224 acquires the latest interest region coordinate information presently stored in the storage unit 206 and compares the acquired information with the interest region coordinate information acquired from the image display control apparatus 101. If the compared data are different from each other, the control region acquisition unit 224 causes the storage unit 206 to store the interest region coordinate information acquired from the image display control apparatus 101, as new interest region coordinate information. If the interest region coordinate information stored in the storage unit 206 is identical to the acquired interest region coordinate information, the control region acquisition unit 224 does not store the interest region coordinate information in the storage unit 206. By repeating the above-mentioned processing, the control region acquisition unit 224 continues periodic acquisition of the coordinate data.

The control region acquisition unit 224 acquires each backlight emission region that has an adverse influence on the luminance of an image region identified by the interest region coordinate information (hereinafter, referred to as “interfering backlight region”) with reference to the interest region coordinate information and the backlight emission region information. Then, the control region acquisition unit 224 causes the storage unit 225 to store the acquired interfering backlight region. More specifically, the control region acquisition unit 224 identifies the interfering backlight region by identifying a backlight emission influence region at least a part of which overlaps with the interest region 310 from a plurality of backlight emission influence regions with reference to the interest region coordinate information and the backlight emission region information. The control region acquisition unit 224 designates each identified interfering backlight region as a first region and designates a region excluding the first region as a second region. Then, the control region acquisition unit 224 causes the storage unit 225 to store the first and second regions.

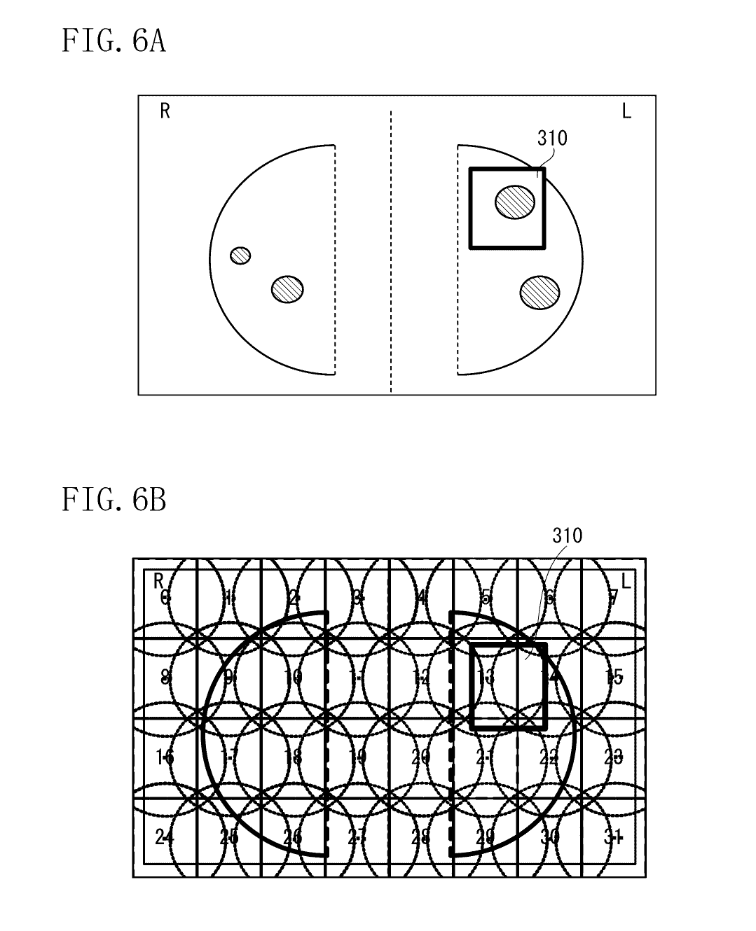

FIGS. 6A and 6B illustrate the interfering backlight region (i.e., the first region). More specifically, FIG. 6A illustrates the interest region 310 designated by the user. FIG. 6B illustrates interfering backlight regions, as backlight emission regions that have an adverse influence on the luminance value of the interest region 310. In FIG. 6B, each backlight emission region including the center of a white circle is the above-mentioned first region. Further, in FIG. 6B, each backlight emission region including the center of a gray circle is the second region. In the example illustrated in FIG. 6B, the 5^{th}, 6^{th}, 12^{th}, 13^{th}, 14^{th}, 20^{th}, 21^{st}, and 22^{nd} backlight emission regions (N=5, 6, 12, 13, 14, 20, 21, and 22) constitute a practical range of the first regions. As understood from FIG. 6B, neighboring interfering backlight regions are overlapped with each other. Therefore, each overlapped portion of the neighboring interfering backlight regions becomes brighter compared to non-overlapped portions.

[Suppression of Halation]

The backlight control unit 226 sets the backlight luminance of the second region to a value lower than the present luminance through the local dimming processing. In this respect, the second region can be referred to as a “backlight luminance control target region” that becomes a target of the luminance adjustment to be performed by the backlight control unit 226. In the case, an adjusted backlight luminance difference occurs in the boundary between the interest region 310 and the region other than the interest region 310. As a result, the light may leak from the first region where the backlight is brighter into the second region where the backlight is darker. This phenomenon is referred to as “halation.” For example, according to the example illustrated in FIG. 6B, the 11^{th} backlight emission region is the second region that tends to cause halation because the 11^{th} backlight emission region is significantly influenced by the neighboring 12^{th} backlight interfering backlight region.

Therefore, the video signal correction unit 222 acquires the backlight emission region information and the information to identify the second region from the backlight control unit 226. The video signal correction unit 222 is an image correction unit configured to perform image correction processing on an image in such a way as to reduce pixel values in a boundary region of the acquired second region, which is positioned within a predetermined range from the first region. The predetermined range is a region where the second region is overlapped with the backlight emission influence region.

More specifically, the video signal correction unit 222 calculates and acquires a reduction amount of an image pixel value in the second region based on the image pixel value in the second region. In a case where the display unit 228 is a liquid crystal monitor, the image pixel value determines an orientation angle of a liquid crystal element that constitutes the pixel and the orientation angle determines a transmission amount of the backlight. Accordingly, if the image pixel value is large, the quantity of backlight transmitting the pixel is greater compared to that in the case where the image pixel value is small. Therefore, if the pixel value in a region where the second region overlaps with the interfering backlight region is higher, the video signal correction unit 222 increases the reduction amount of the pixel value, compared to the case where the pixel value is smaller. Therefore, the video signal correction unit 222 can effectively reduce the adverse influence of the halation. In particular, the video signal correction unit 222 corrects the video signal in such a way as to hold the luminance of a display range of diagnosis related information (e.g., annotation displayed in the second region) at a constant value.

As mentioned above, the first region (i.e., the interfering backlight region) is the region including the interest region 310 designated by the user, which is wider than the interest region 310. Therefore, the video signal correction unit 222 can reduce the pixel values of the partial image region of the first region excluding the interest region 310. Therefore, the region other than the interest region 310 becomes darker. The user can concentrate on observation of the interest region 310.

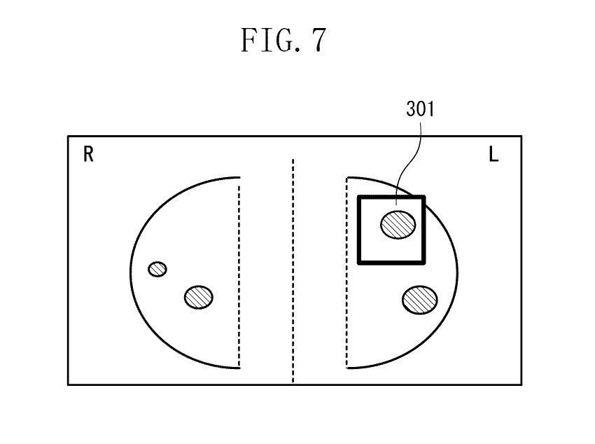

FIG. 7 illustrates luminance adjustment that can be performed by the backlight control unit 226. More specifically, FIG. 7 illustrates a processed result of the image illustrated in FIG. 6A, which has been subjected to the local dimming processing that has been performed by the backlight control unit 226 and the luminance adjustment processing performed by the video signal correction unit 222. The example illustrated in FIG. 7 illustrates a result, which can be obtained when the video signal correction unit 222 reduces the pixel values of the image in a partial region of the first region excluding the interest region 310. As illustrated in FIG. 7, the luminance value of the interest region 310 can be held appropriately and the luminance value of the region excluding the interest region 310 becomes lower compared to the interest region 310.

[Processing Flow of Image Display System]

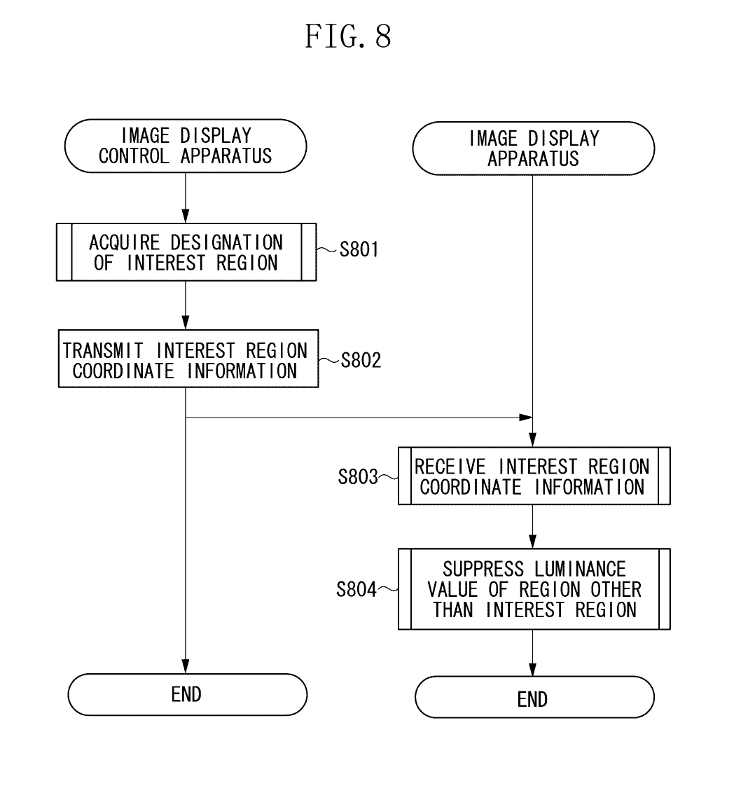

FIG. 8 is a flowchart illustrating a flow of backlight adjustment processing that can be performed by the image display system 1 according to the first exemplary embodiment. The processing of the flowchart illustrated in FIG. 8 starts, for example, in response to a startup of the image display control apparatus 101.

In step S801, the diagnosis target region acquisition unit 208 of the image display control apparatus 101 acquires the interest region coordinate information that designates the interest region 310, based on a user operation via the user interface 205. In step S802, the communication control unit 203 of the image display control apparatus 101 transmits the interest region coordinate information acquired by the diagnosis target region acquisition unit 208 to the image display apparatus 102. In step S803, the communication control unit 223 of the image display apparatus 102 receives the interest region coordinate information from the image display control apparatus 101. In step S804, the image display apparatus 102 suppresses the luminance value of the region other than the interest region 310, based on the interest region coordinate information received from the image display control apparatus 101. If the image display apparatus 102 completes the processing for suppressing the luminance value of the region other than the interest region 310, the image display system 1 terminates the processing of the flowchart illustrated in FIG. 8.

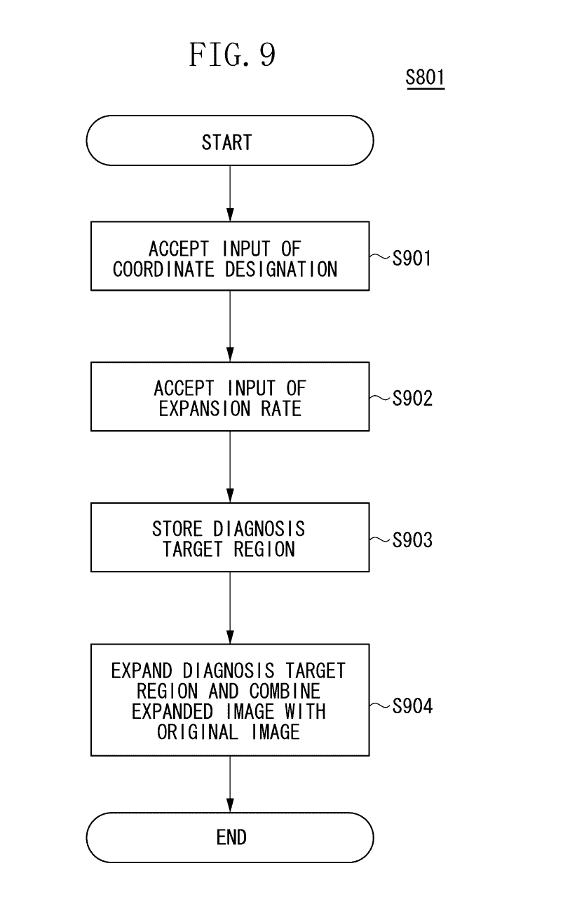

FIG. 9 is a flowchart illustrating a flow of interest region acquisition processing that can be performed by the image display control apparatus 101 according to the first exemplary embodiment (i.e., details of the processing to be performed in step S801 in FIG. 8).

In step S901, the diagnosis target region acquisition unit 208 accepts an input of the interest region coordinate information designated by the user via the user interface 205 with respect to a medical image displayed by the display unit 228. Subsequently, in step S902, the diagnosis target region acquisition unit 208 accepts an input of an expansion rate indicating the enlargement degree of the interest region 310 from the user.

As mentioned above, the user can operate the GUI equipped for the viewer to designate the expansion rate. Alternatively, the user can operate the user interface 205 to designate the expansion rate.

In step S903, the diagnosis target region acquisition unit 208 stores the acquired information (i.e., the interest region coordinate information and the expansion rate) in the storage unit 206 via the internal bus 207. In step S904, under the control of the image display control unit 210, the composite image display unit 211 refers to the interest region coordinate information, the expansion rate, and image data to be displayed by the display unit 228 and expands the image data corresponding to the interest region coordinate information with the designated expansion rate. Then, the composite image display unit 211 combines the expanded image data with the original image data.

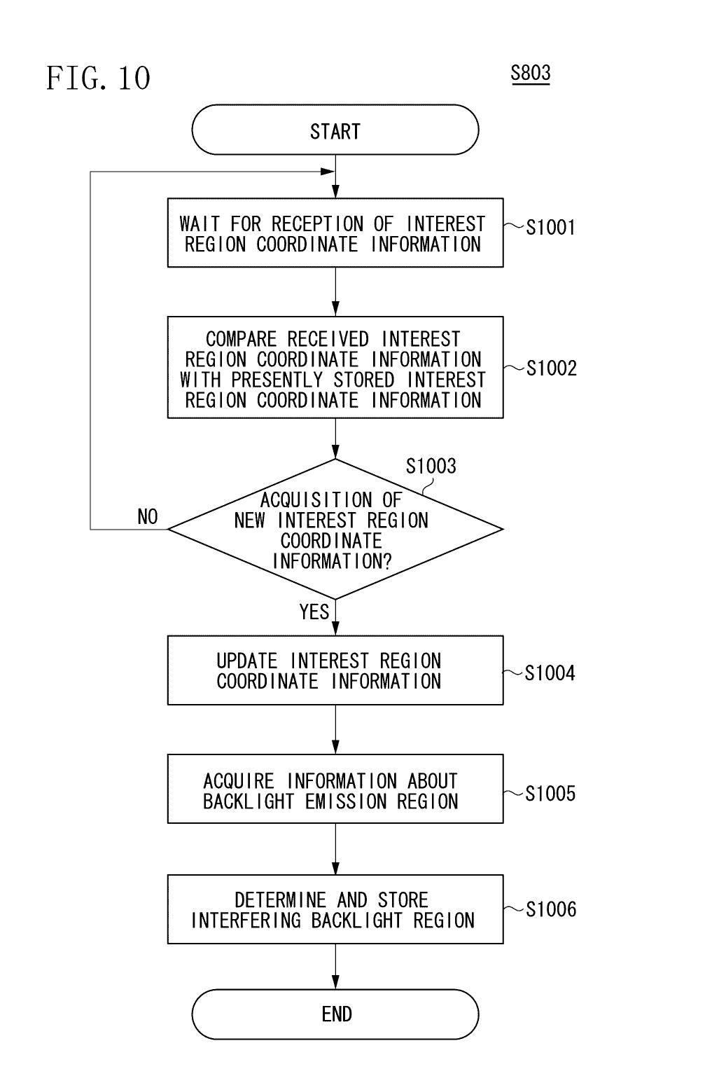

FIG. 10 is a flowchart illustrating a flow of interest region coordinate information reception processing that can be performed by the image display apparatus 102 according to the first exemplary embodiment (i.e., details of the processing to be performed in step S803 in FIG. 8).

In step S1001, the control region acquisition unit 224 of the image display apparatus 102 waits for reception (or acquisition) of the interest region coordinate information transmitted from the image display control apparatus 101 via the communication control unit 223. In step S1002, the control region acquisition unit 224 compares the received interest region coordinate information with the interest region coordinate information presently stored in the storage unit 225. If the received interest region coordinate information is different from the presently stored interest region coordinate information, more specifically, when new interest region coordinate information has been acquired (YES in step S1003), then in step S1004, the control region acquisition unit 224 causes the storage unit 225 to store the coordinate data acquired from the image display control apparatus 101, as new coordinate data, and update the interest region coordinate information. If the compared interest region coordinate data coincide with each other (NO in step S1003), the control region acquisition unit 224 does not cause the storage unit 225 to store the coordinate data. The operation returns to step S1001 to continue periodic acquisition of the interest region coordinate information.

In step S1005, the control region acquisition unit 224 acquires the backlight emission region information from the storage unit 225. In step S1006, the control region acquisition unit 224 acquires the interfering backlight region based on the interest region coordinate information and the backlight emission region information and stores the acquired interfering backlight region in the storage unit 225. In this case, the region excluding the interfering backlight region (i.e., the first region) is the second region. Therefore, information identifying the interfering backlight region can be regarded as information identifying the second region.

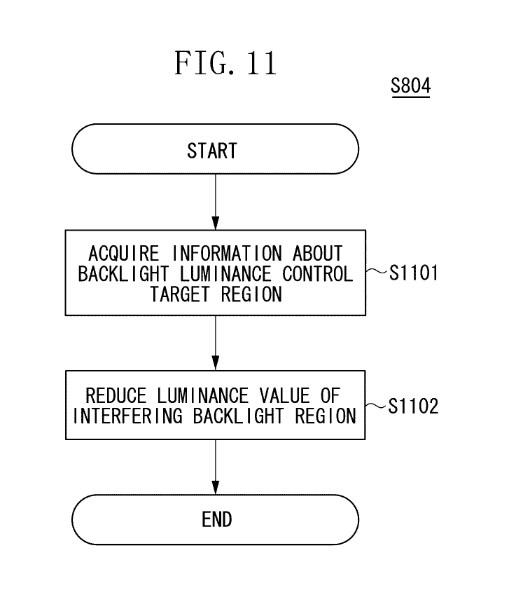

FIG. 11 is a flowchart illustrating a flow of luminance value suppression processing that can be performed by the image display apparatus 102 according to the first exemplary embodiment (i.e., details of the processing to be performed in step S804 illustrated in FIG. 8).

In step S1101, the backlight control unit 226 acquires information about the second region (i.e., the backlight luminance control target region) from the storage unit 225. In step S1102, the backlight control unit 226 performs the local dimming processing on the acquired backlight emission region and reduces the luminance value of the backlight 227 in the processing target region.

[Effects of First Exemplary Embodiment]

As described above, the image display system 1 according to the first exemplary embodiment reduces the light emission luminance of the backlight in the image region excluding the interest region 310 designated by the user. Therefore, the region other than the interest region 310 becomes darker. The user can concentrate on observation of the interest region 310 because the region other than the interest region 310 does not stand out.

In particular, in the image display system 1 according to the first exemplary embodiment, the backlight control unit 226 adjusts the display luminance of the region other than the interest region 310 by controlling the backlight 227 of the display unit 228. Therefore, the image display system 1 according to the first exemplary embodiment can realize the luminance adjustment reflecting the display characteristics of the display unit 228.

Further, the video signal correction unit 222 adjusts the pixel values of the image in such a way as to suppress the influence of the halation that cannot be sufficiently reduced by the luminance adjustment of the backlight 227 performed by the backlight control unit 226. Therefore, the image display system 1 according to the first exemplary embodiment can precisely reduce the light emission amount in the region other than the interest region 310 (i.e., the user's observation target).

Hereinafter, a second exemplary embodiment will be described in detail. In the first exemplary embodiment, the control region acquisition unit 224 provided in the image display apparatus 102 determines the control region of the backlight 227. In contrast, the second exemplary embodiment is different from the first exemplary embodiment in that the image display control apparatus 101 acquires the backlight emission region information from the image display apparatus 102 and calculates an adjustment place and a luminance value of the backlight 227 with reference to the interest region 310 designated by the user. Hereinafter, the image display system 1 according to the second exemplary embodiment will be described in detail, although constituent components and portions common to those of the image display system 1 described in the first exemplary embodiment are omitted or simplified appropriately.

[Functional Configuration of Image Display System]

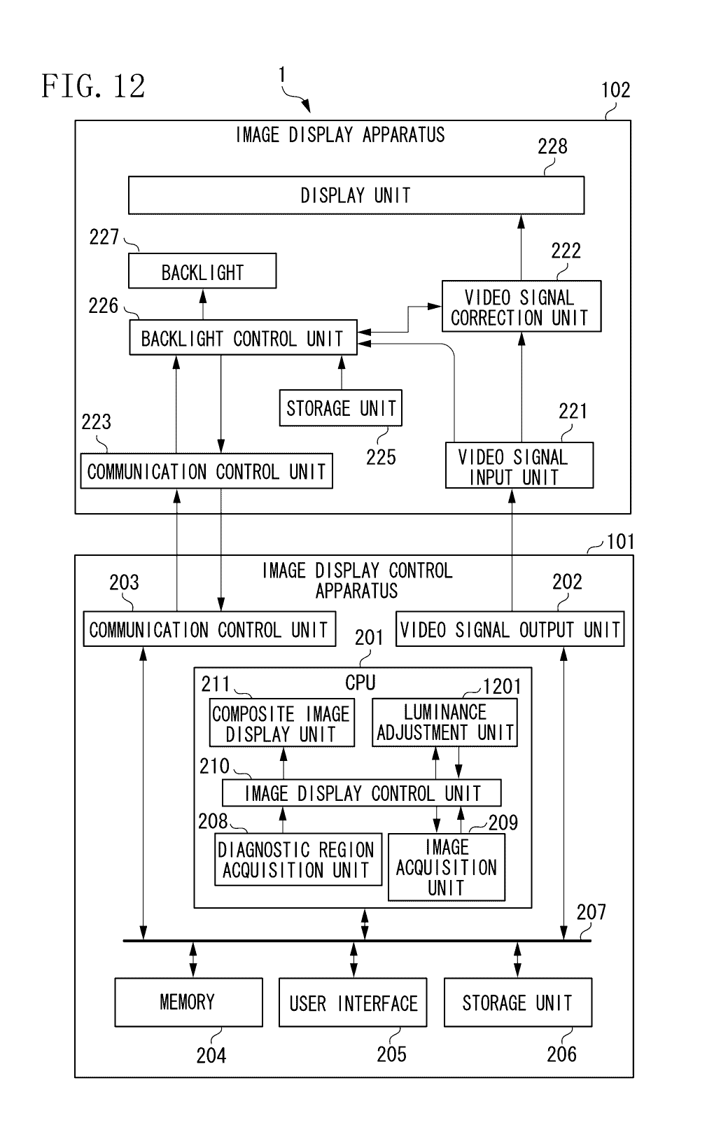

FIG. 12 schematically illustrates a functional configuration of the image display system 1 according to the second exemplary embodiment. The image display system 1 according to the second exemplary embodiment is similar to the image display system 1 described in the first exemplary embodiment, in that the image display system 1 is constituted by the image display control apparatus 101 and the image display apparatus 102. However, the image display control apparatus 101 according to the second exemplary embodiment is different from the image display control apparatus 101 described in the first exemplary embodiment in that a luminance adjustment unit 1201 is additionally provided. Further, the image display apparatus 102 according to the second exemplary embodiment does not include the control region acquisition unit 224, which is included in the image display apparatus 102 according to the first exemplary embodiment.

The luminance adjustment unit 1201 can acquire the backlight emission region information (i.e., the information indicating the display characteristics of the display unit 228) from the storage unit 225 of the image display apparatus 102, via the image display control unit 210, the internal bus 207, and the communication control unit 203. The backlight control unit 226 of the image display apparatus 102 acquires the preliminarily stored backlight emission region information from the storage unit 225 in response to a backlight emission region information acquisition request received from the image display control apparatus 101 via the communication control unit 223. The backlight control unit 226 transmits the acquired backlight emission region information and present luminance information about the backlight 227 to the luminance adjustment unit 1201 of the image display control apparatus 101.

The luminance adjustment unit 1201 acquires the first and second regions with reference to the acquired backlight emission region information and the interest region coordinate information that indicates the interest region 310 designated by the user. The luminance adjustment unit 1201 calculates and acquires an adjustment amount of the backlight 227 based on the pixel values of the image corresponding to the second region. The luminance adjustment unit 1201 outputs the calculated luminance adjustment amount of the backlight 227 to the backlight control unit 226 of the image display apparatus 102. The backlight control unit 226 of the image display apparatus 102 controls the backlight luminance based on the received value.

[Processing Flow of Image Display System]

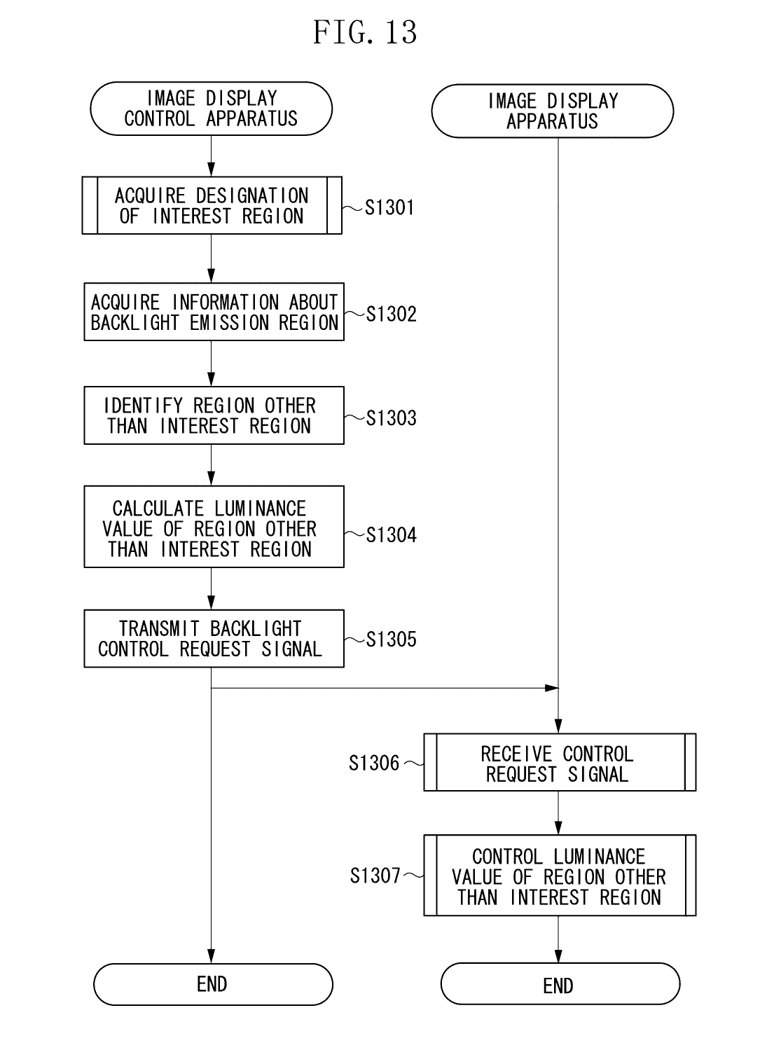

FIG. 13 is a flowchart illustrating a flow of backlight adjustment processing that can be performed by the image display system 1 according to the second exemplary embodiment. The processing of the flowchart illustrated in FIG. 13 starts, for example, in response to a startup of the image display control apparatus 101.

In step S1301, the diagnosis target region acquisition unit 208 of the image display control apparatus 101 acquires the interest region coordinate information that identifies the interest region 310 designated by the user via the user interface 205. Details of the processing to be performed in step S1301 are similar to the details of the processing performed in step S801 illustrated in FIG. 8 having been described with reference to FIG. 9. In step S1302, the luminance adjustment unit 1201 acquires the backlight emission region information from the storage unit 225 of the image display apparatus 102 via the image display control unit 210, the internal bus 207, and the communication control unit 203.

In step S1303, the luminance adjustment unit 1201 identifies the second region, namely, the image region other than the interest region 310, with reference to the interest region coordinate information and the backlight emission region information. In step S1304, the luminance adjustment unit 1201 calculates the luminance value of the backlight 227 so that the luminance of the image corresponding to the determined second region becomes lower than the luminance of the image corresponding to the first region. In step S1305, the luminance adjustment unit 1201 transmits a backlight control request signal to the image display apparatus 102, in order to equalize the luminance of the backlight 227 with the calculated luminance.

In step S1306, the backlight control unit 226 of the image display apparatus 102 receives the backlight control request signal transmitted, via the communication control unit 223, from the luminance adjustment unit 1201 of the image display control apparatus 101. In step S1307, the backlight control unit 226 sets the luminance of the backlight 227 in the second region to a value lower than the present luminance, through the local dimming processing, based on the received backlight control request signal, thereby realizing image luminance value control in the second region. In the case, similar to the image display system 1 according to the first exemplary embodiment, the video signal correction unit 222 may perform video signal correction processing in such a way as to suppress the halation occurring in the boundary between the first and second regions. Further, the video signal correction unit 222 may reduce the pixel values in the partial image region of the first region other than the interest region 310.

[Effects of Second Exemplary Embodiment]

As described above, the image display system 1 according to the second exemplary embodiment is similar to the image display system 1 according to the first exemplary embodiment in reducing the light emission luminance of the backlight in the partial image region excluding the interest region 310 designated by the user. Therefore, the region other than the interest region 310 becomes darker. The user can concentrate on observation of the interest region 310 because the region other than the interest region 310 does not stand out.

In particular, the image display system 1 according to the second exemplary embodiment is characterized in that the image display control apparatus 101 generates the backlight control request signal. Therefore, unlike the image display system 1 described in the first exemplary embodiment, the image display system 1 according to the second exemplary embodiment can use any existing display apparatus as long as the image display apparatus 102 can perform the local dimming processing . In other words, the costs of the image display system 1 can be suppressed because it is unnecessary to provide the dedicated image display apparatus 102.

Hereinafter, a third exemplary embodiment will be described in detail. In each of the first exemplary embodiment and the second exemplary embodiment, the image display control apparatus 101 and the image display apparatus 102 are constituted as independent apparatuses. The image display system 1 according to the third exemplary embodiment is different from the image display system 1 described in the first and second exemplary embodiments in that the image display control apparatus 101 is incorporated in the image display apparatus 102. In other words, the image display system 1 according to the third exemplary embodiment is constituted as a single apparatus, which integrates the image display control apparatus with the image display apparatus. For example, the image display system 1 according to the third exemplary embodiment can be realized as a note PC or a tablet terminal. Hereinafter, the image display system 1 according to the third exemplary embodiment will be described in detail, although constituent components and portions common to those of the image display system 1 described in each of the above-mentioned exemplary embodiments are omitted and simplified appropriately.

[Functional Configuration of Image Display System]

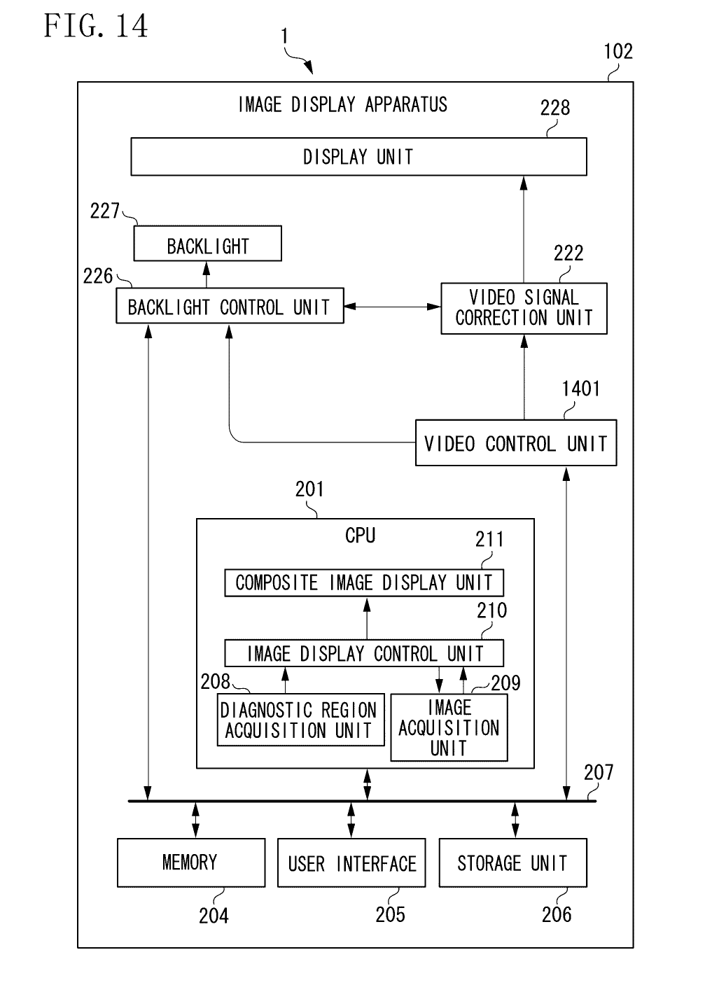

FIG. 14 schematically illustrates a functional configuration of the image display system 1 according to the third exemplary embodiment. As illustrated in FIG. 14, the image display system 1 according to the third exemplary embodiment is a single apparatus in which the image display control apparatus 101 and the image display apparatus 102 are integrated together. In the following description, the image display system 1 is described as the image display apparatus 102 that incorporates the image display control apparatus 101. However, the image display system 1 according to the third exemplary embodiment can be regarded as the image display control apparatus 101 that includes the image display apparatus 102, as one constituent component thereof.

The image display apparatus 102 according to the third exemplary embodiment does not include the video signal output unit 202, the communication control unit 203, the video signal input unit 221, and the communication control unit 223 provided in the image display system 1 according to each of the above-mentioned exemplary embodiments. Instead, the image display apparatus 102 according to the third exemplary embodiment includes a video control unit 1401. Further, the functions of the storage unit 206 according to each of the above-mentioned exemplary embodiments are integrated into the functions of the storage unit 225.

The video control unit 1401 can control a video signal based on which the display unit 228 can display an image. The video signal correction unit 222 converts the video signal processed by the video control unit 1401 into video data having a format that can be displayed by the display unit 228. Further, the video control unit 1401 can perform processing similar to that of the control region acquisition unit 224 described in the first exemplary embodiment. More specifically, the video control unit 1401 determines the first and second regions with reference to the backlight emission region information stored in the storage unit 225 and the interest region information. The video control unit 1401 calculates and acquires the light emission luminance value of the backlight in the second region based on the determined second region and the pixel values of the image corresponding to the second region.

[Processing Flow of Image Display System]

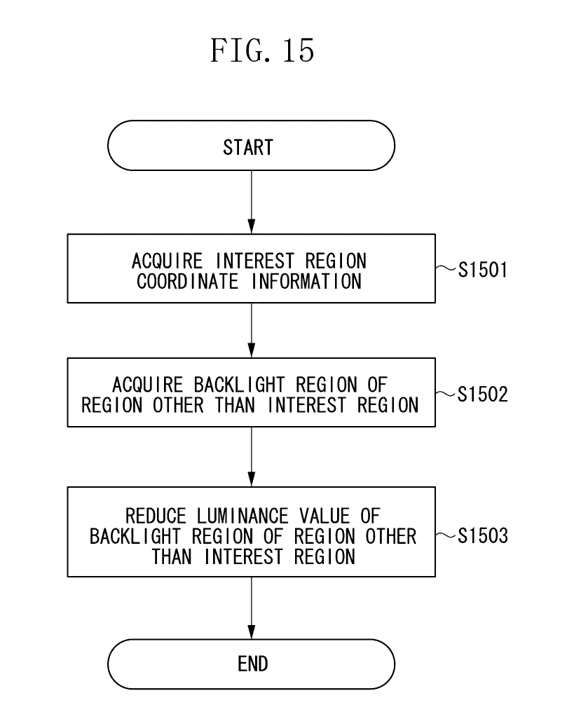

FIG. 15 is a flowchart illustrating a flow of backlight adjustment processing that can be performed by the image display system 1 according to the third exemplary embodiment. The processing of the flowchart illustrated in FIG. 15 starts, for example, in response to a startup of the image display apparatus 102.

In step S1501, the diagnosis target region acquisition unit 208 of the image display apparatus 102 causes the storage unit 225 to store the interest region coordinate information designated by the user via the user interface 205. In step S1502, the diagnosis target region acquisition unit 208 acquires the above-mentioned second region, i.e., the region excluding the backlight emission region that has an adverse influence on the luminance of the image region identified by the interest region coordinate information, with reference to the interest region coordinate information and the backlight emission region information stored in the storage unit 225. In step S1503, the backlight control unit 226 sets the luminance of the backlight 227 in the second region to a value lower than the present luminance, through the local dimming processing. In the case, similar to the image display system 1 according to the above-mentioned each exemplary embodiment, the video signal correction unit 222 corrects the video signal in such a way as to reduce the halation that may occur in the boundary between the second region and the first region. Further, the video signal correction unit 222 may reduce the pixel values in the partial image region of the first region other than the interest region 310.

[Effects of Third Exemplary Embodiment]

As described above, the image display system 1 according to the third exemplary embodiment reduces the light emission luminance of the backlight in the image region excluding the interest region 310 designated by the user. Therefore, the region other than the interest region 310 becomes darker. The user can concentrate on observation of the interest region 310 because the region other than the interest region 310 does not stand out.

In particular, the image display system 1 according to the third exemplary embodiment is characterized in that the image display apparatus 102 has functions similar to those of the image display control apparatus 101 described in the above-mentioned each exemplary embodiment. The video cable 103 and the communication cable 104 become unnecessary because the image display control apparatus 101 and the image display apparatus 102 are united together. The image display system 1 can be downsized as a whole.

The present invention has been described with reference to some exemplary embodiments. The present invention encompasses another exemplary embodiment obtainable by arbitrarily combining the above-mentioned exemplary embodiments. In this case, the combined exemplary embodiment has effects similar to those of the original exemplary embodiments.

Further, the technical range of the aspect of the embodiments is not limited to the above-mentioned exemplary embodiments. It is apparent to a person skilled in the art that various changes and improvements can be added to the above-mentioned exemplary embodiments. Hereinafter, some modified examples of the above-mentioned exemplary embodiments will be described in detail below.

<First Modified Example>

In the above-mentioned each exemplary embodiment, the image display system 1 reduces the light emission luminance of the backlight 227 in the second region, while holding the light emission luminance of the backlight 227 in the first region, as mentioned above. In the present modified example, the backlight control unit 226 may be configured to change the light emission luminance of the backlight 227 in the second region in response to a change of the image display mode.

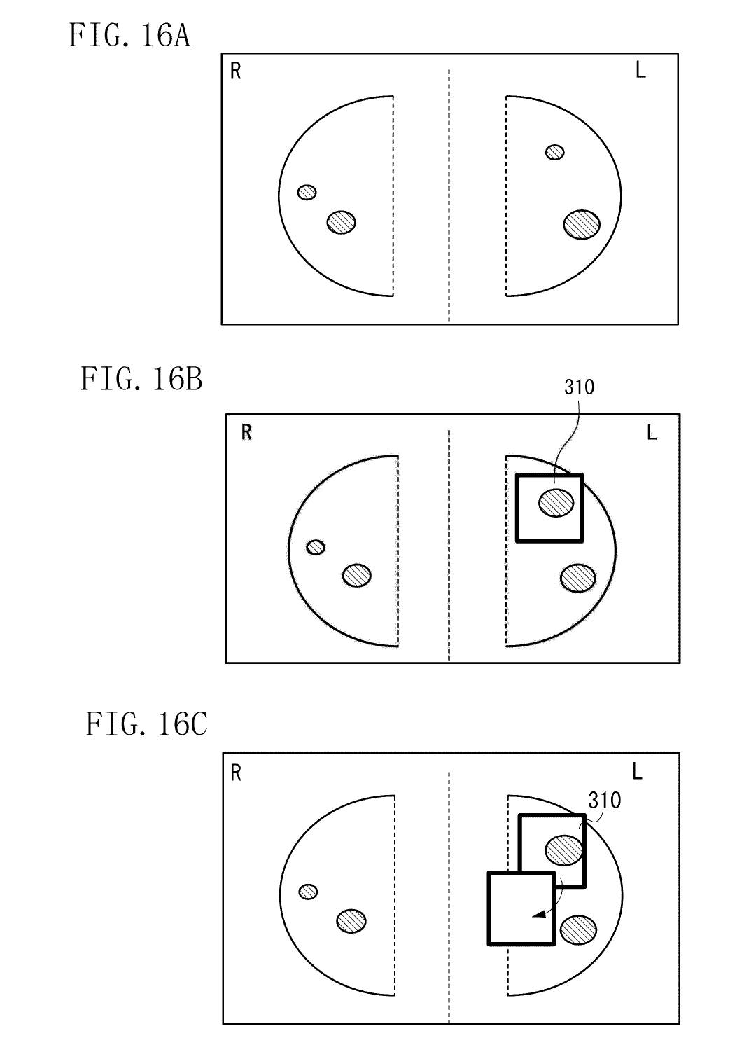

FIGS. 16A to 16C illustrate exemplary luminance adjustment for changing the luminance according to various conditional changes in the enlarged display function of the viewer. More specifically, FIG. 16A illustrates an exemplary screen of the viewer in an initial display mode where the enlarged display function is not yet performed. The display mode of the viewer illustrated in FIG. 16A does not include the interest region 310 because execution of the enlarged display function is not yet instructed by the user. Therefore, the image is not yet subjected to the above-mentioned adjustment of the light emission luminance of the backlight 227 in the second region.

FIG. 16B illustrates an exemplary screen of the viewer that has shifted into an enlarged display function state in response to an enlarged display instruction entered via the user interface 205. According to the display mode of the exemplary viewer illustrated in FIG. 16B, the adjustment of the light emission luminance of the backlight 227 in the second region is performed because the viewer is currently executing the enlarged display function. More specifically, the luminance of the region other than the interest region is lower than that of the diagnosis target region. If the user operates the user interface 205 to terminate the enlarged display function state of the viewer illustrated in FIG. 16B, the light emission luminance adjustment processing terminates correspondingly. The viewer returns to the state illustrated in FIG. 16A.

On the other hand, FIG. 16C illustrates an exemplary screen of the viewer, which can be displayed when the user operates the user interface 205 to move the interest region 310 or change the size of the interest region 310. In the display mode of the viewer illustrated in FIG. 16C, movement of the interest region 310 or resizing of the interest region 310 is currently progressing. In this case, the user designates a destination point of the interest region 310 currently moving or a desired size of the interest region 310 currently expanding. Therefore, the backlight control unit 226 restricts the adjustment of the light emission luminance of the backlight 227 in the second region if the viewer is accepting a user instruction to move or resize the interest region 310. Determining the moving destination or the size change of the interest region 310 is easy for the user because the entire image is brightly displayed.

If the user operates the user interface 205 to designate the position of the interest region 310 or the size of the interest region 310, the backlight control unit 226 adjusts the light emission luminance of the backlight 227 in the second region. The viewer shifts to the display mode illustrated in FIG. 16B. Further, if the user operates the user interface 205 to terminate the enlarged display function state when the viewer is in the display mode illustrated in FIG. 16C, the backlight control unit 226 terminates the light emission luminance adjustment processing correspondingly. The viewer returns to the state illustrated in FIG. 16A.

Further, the backlight control unit 226 of the image display system 1 according to the first modified example restricts the adjustment of the light emission luminance of the backlight 227 in the second region if the viewer is in a predetermined display pattern, as described in detail below.

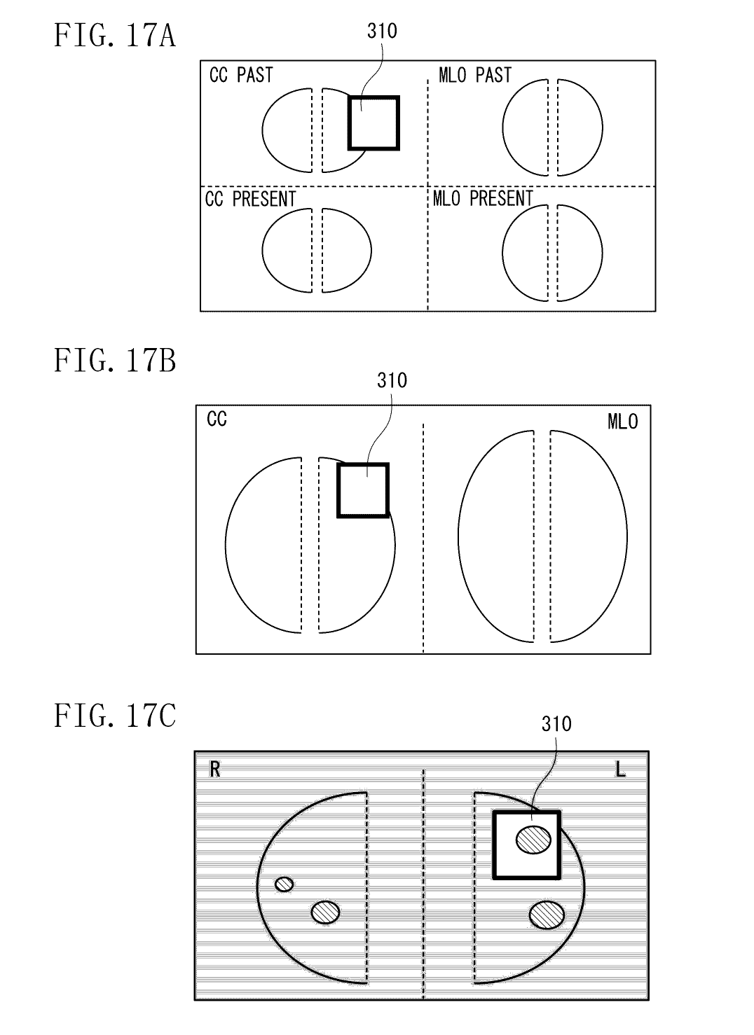

FIGS. 17A to 17C illustrate various display patterns of the image display control unit (i.e., the viewer). More specifically, FIG. 17A illustrates an exemplary screen of the viewer in a 4-division display mode, in which present and past mammography images in the CC direction and present and past mammography images in the Medio-Lateral Oblique (MLO) direction are sequentially displayed.

The display mode of the viewer illustrated in FIG. 17A is used when the user evaluates the presence of any larger difference between respective images sequentially displayed. Therefore, when the viewer is in the 4-division display mode illustrated in FIG. 17A, the backlight control unit 226 does not adjust the light emission luminance of the backlight 227 in the second region even if the user instruction is the enlargement of the interest region 310.

FIG. 17B illustrates an exemplary screen of the viewer in a 2-division display mode, in which a single mammography image in the CC direction and a single mammography image in the MLO direction are sequentially displayed. Similar to the case where the viewer is in the 4-division display mode, the display pattern of the viewer in the 2-division display mode is used when the user evaluates the presence of any larger difference between compared images. Therefore, when the viewer is in the 2-division display mode illustrated in FIG. 17B, the backlight control unit 226 restricts the adjustment of the light emission luminance of the backlight 227 in the second region even if the user instruction is the enlargement of the interest region 310.

FIG. 17C illustrates an exemplary screen of the viewer in a mode for displaying a mammography image of a left bust and a mammography image of a right bust in the MLO direction or in the CC direction. Unlike the display modes of the viewer illustrated in FIGS. 17A and 17B, the display mode of the viewer illustrated in FIG. 17C is used when the user evaluates the presence of a tumor or detects a calcified portion. Therefore, when the viewer is in the display mode illustrated in FIG. 17C, the backlight control unit 226 adjusts the light emission luminance of the backlight 227 in the second region.

As described above, the image display control unit 210 of the image display system 1 according to the first modified example of the present exemplary embodiment displays the viewer in various display modes. When the display mode of the viewer is a predetermined display mode, the backlight control unit 226 restricts the control of the light emission luminance of the region corresponding to the second region. For example, if the mode for expanding an operation target image in the interest region 310 or moving the position of the interest region 310 is selected as the display mode, the backlight control unit 226 restricts the control of the light emission luminance of the region corresponding to the second region. Therefore, the user can efficiently perform a medical image reading work.

As a modified embodiment, each user may be permitted to determine whether to cause the backlight control unit 226 to adjust the light emission luminance of the backlight 227 in the second region according to the function performed by the viewer and the display mode of the viewer. Further, the above-mentioned viewer enlargement function is a mere example of restriction of the luminance adjustment to be performed by the backlight control unit 226. The luminance adjustment control to be performed by the backlight control unit 226 is not limited to the enlargement function. Any other function can be a target of the luminance adjustment control as long as the user can designate the interest region 310.

<Second Modified Example>

The image display system 1 having been described in the above-mentioned each exemplary embodiment reduces the light emission luminance of the backlight 227 in the second region while holding the light emission luminance of the backlight 227 in the first region. As a modified example, the image display system may change the light emission luminance of the backlight 227 in the second region in response to a change of the information relating to pixels included in the interest region 310.

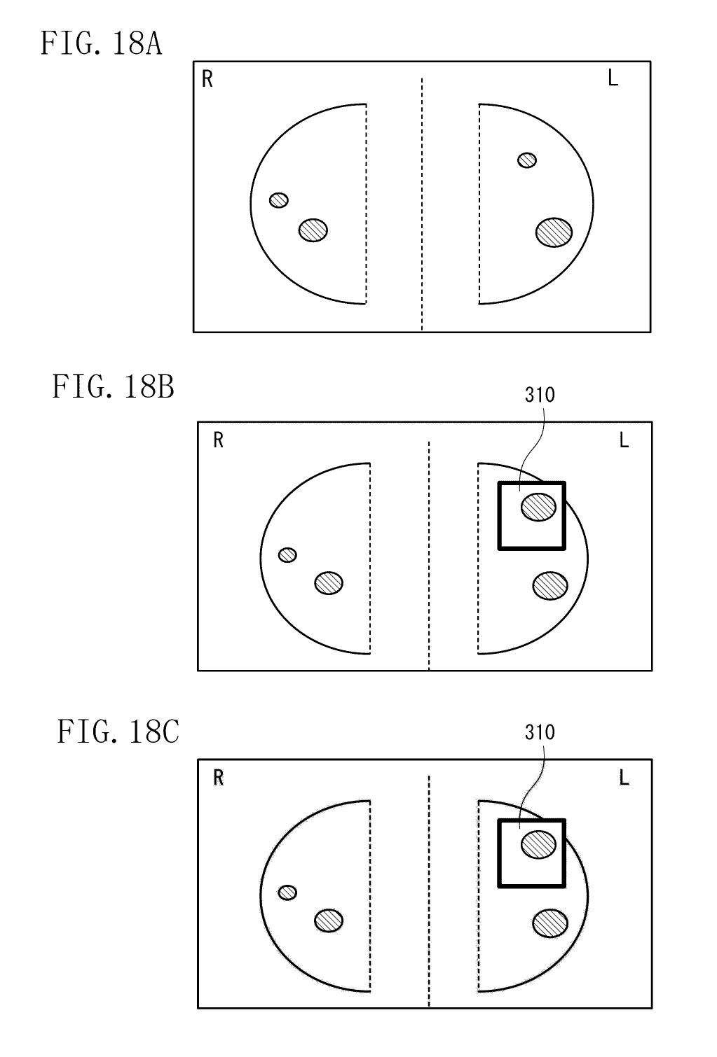

FIGS. 18A to 18C illustrate an exemplary relationship between a change of the information relating to the pixels included in the interest region 310, and the luminance value of the second region other than the interest region. More specifically, FIG. 18A illustrates an exemplary screen of the viewer in an initial display mode where the enlarged display function is not yet performed. FIG. 18B illustrates an exemplary screen of the viewer that has shifted to the enlarged display function state in response to an enlarged display instruction entered via the user interface 205. FIG. 18C illustrates an exemplary screen of the viewer that can be displayed when the user increases the expansion rate of the interest region 310 via the user interface 205, compared to the exemplary screen illustrated in FIG. 18B.

The backlight control unit 226 according to the second modified example reduces the light emission luminance of the backlight 227 in the second region when the display of the interest region 310 is enlarged as illustrated in FIG. 18B, similar to the backlight control unit 226 according to the above-mentioned each exemplary embodiment. In the exemplary viewer illustrated in FIG. 18C, it is assumed that an average luminance of the image in the interest region 310 becomes lower compared to the exemplary viewer illustrated in FIG. 18B because the expansion rate of the interest region 310 has been increased by the user. In this case, the backlight control unit 226 further reduces the light emission luminance of the backlight 227 in the second region. For example, it is assumed that the exemplary screen illustrated in FIG. 18B can be obtained when the backlight control unit 226 reduces the luminance value of the backlight 227 in the second region to 60% while holding the luminance value of the backlight 227 in the first region at 100%. In contrast, the exemplary screen illustrated in FIG. 18C can be obtained when the backlight control unit 226 reduces the luminance value of the backlight 227 in the second region to 30% while holding the luminance value of the backlight 227 in the first region at 100%.

As mentioned above, the backlight control unit 226 according to the second modified example changes the light emission luminance of the region corresponding to the second region in response to a change of the information relating to the pixels included in the interest region 310. In this case, “the information relating to the pixels included in the interest region 310” is, for example, statistical information about the pixels included in the interest region 310. More specifically, “the information relating to the pixels included in the interest region 310” is an average luminance value, a median luminance value, a norm luminance value, or a maximum value of the pixels included in the interest region 310 or can be the total number of the pixels included in the interest region 310. According to the examples illustrated in FIGS. 18A to 18C, the backlight control unit 226 increases the suppression amount of the luminance value of the backlight 227 in the second region if the average luminance value of the pixels included in the interest region 310 is smaller, compared to the case where the average luminance value is larger. Therefore, the user can concentrate on observation of the interest region 310.

The change of the information relating to an image included in the interest region 310 is not limited to a case where the user changes the expansion rate of the interest region 310. For example, the information relating to the image included in the interest region 310 changes when the interest region 310 is subjected to the windowing processing.

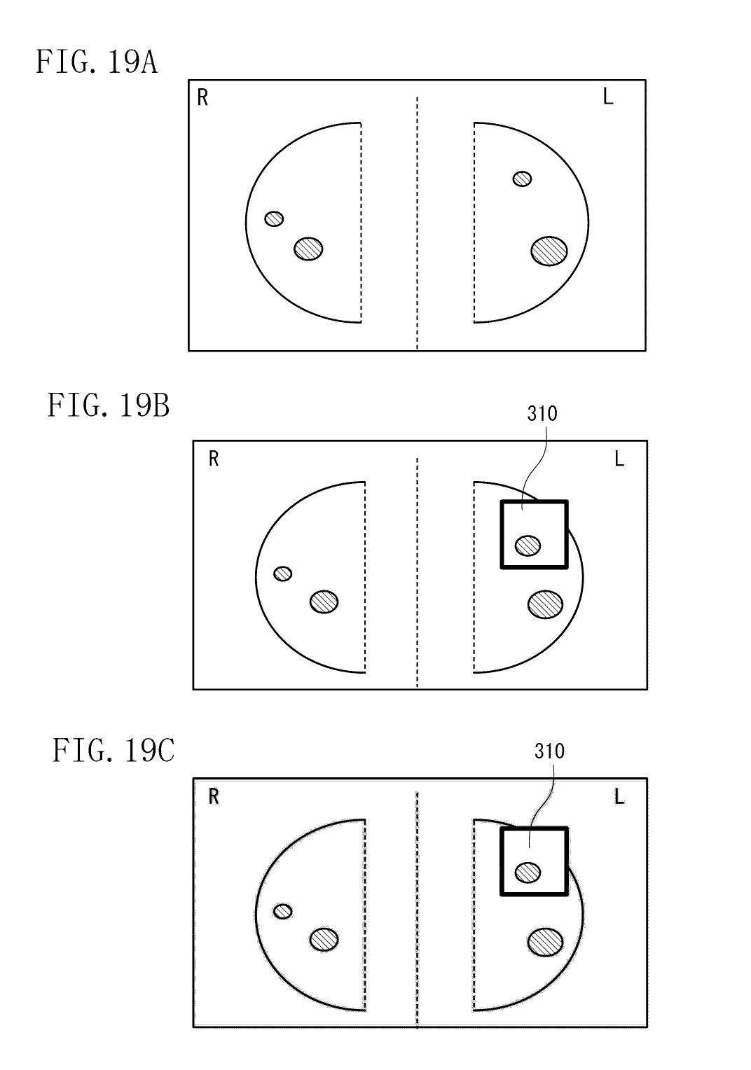

FIGS. 19A to 19C illustrate another exemplary relationship between a change of the information relating to the pixels included in an interest region 310, and a luminance value of the second region other than the interest region. More specifically, FIGS. 19A to 19C are views illustrating a method for determining the luminance value of a region other than the interest region according to a change of a window level in the interest region 310 that is variable according to a windowing function that can be realized by the viewer. In the present exemplary embodiment, “windowing” processing includes adjusting the window level and a window width in such a way as to convert the window width into the maximum number of gradations that can be displayed by the display unit 228. The “window width” represents the range of adjustment target pixel values and the window level represents the central pixel value within the window width.

FIG. 19A illustrates an exemplary screen of the viewer in an initial display mode where the windowing function is not yet performed. Further, FIG. 19B illustrates an exemplary screen of the viewer that has shifted to a windowing state in response to a user instruction via the user interface 205 to perform the windowing processing on the interest region 310. FIG. 19C illustrates an exemplary screen of the viewer in a case where the user has reduced the window level via the user interface 205, compared to the exemplary screen illustrated in FIG. 19B.

Similar to the backlight control unit 226 described in each of the above-mentioned exemplary embodiments, the backlight control unit 226 according to the second modified example reduces the light emission luminance of the backlight 227 in the second region when the display of the interest region 310 is enlarged as illustrated in FIG. 19B. It is assumed that the exemplary viewer illustrated in FIG. 19C is in a state where the average luminance of the image in the interest region 310 has become lower compared to the exemplary viewer illustrated in FIG. 19B because the user has instructed to perform the windowing processing. In this case, the backlight control unit 226 further reduces the light emission luminance of the backlight 227 in the second region. For example, it is assumed that the exemplary screen illustrated in FIG. 19B can be obtained when the backlight control unit 226 reduces the luminance value of the backlight 227 in the second region to 60% while holding the luminance value of the backlight 227 in the first region at 100%. In contrast, the exemplary screen illustrated in FIG. 19C can be obtained when the backlight control unit 226 reduces the luminance value of the backlight 227 in the second region to 30% while holding the luminance value of the backlight 227 in the first region at 100%.

As mentioned above, the backlight control unit 226 according to the second modified example changes the control amount of the light emission luminance in the region corresponding to the second region in response to a change of the information relating to the pixels included in the interest region 310, similar to the backlight control unit 226 according to the first modified example. Therefore, the user can concentrate on observation of the interest region 310.

<Third Modified Example>

The control region acquisition unit 224 described in the above-mentioned example reduces the luminance value of the backlight 227 in the second region while holding the luminance value of the backlight 227 in the first region. In contrast, the control region acquisition unit 224 according to the third modified may be configured to change the luminance value of the backlight 227 in the interfering backlight region according to an area overlapping with the interest region 310. More specifically, under the control of the CPU 201, the control region acquisition unit 224 determines a light emission luminance value of a light emission element in which the backlight emission influence region overlaps with the interest region 310 according to an area where the interest region 310 overlaps with a backlight emission influence region that is influenced by light emission by one of a plurality of light emission elements.

More specifically, the control region acquisition unit 224 may lower the luminance value of the backlight 227 in an interfering backlight region that is smaller in the area overlapping with the interest region 310 compared with an interfering backlight region that is larger in the area overlapping with the interest region 310. In general, it is believed that the interfering backlight region that is smaller in the area overlapping with the interest region 310 is a region positioned in a peripheral region of the interest region 310. Accordingly, reducing the luminance value of the backlight 227 in the interfering backlight region that is smaller in the area overlapping with the interest region 310 brings an effect of preventing the light emission from the region other than the interest region 310, from interfering with user's observation. The user can concentrate on observation of the interest region 310.

<Fourth Modified Example>

The images displayed by the display unit 228 in the above-mentioned examples are mainly medical images. However, the images displayed by the display unit 228 are not limited to only the medical images and can be general photographed images including persons and scenes.

Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the aspect of the embodiments has been described with reference to exemplary embodiments, it is to be understood that the aspect of the embodiments is not limited to the disclosed exemplary embodiments. The scope of the following claims is to be accorded the broadest interpretation so as to encompass all such modifications and equivalent structures and functions.

This application claims the benefit of Japanese Patent Application No. 2015-218784, filed Nov. 6, 2015, which is hereby incorporated by reference herein in its entirety.

What is claimed is:

1. An image display apparatus comprising:
a display unit configured to display an image;
a light emission unit configured to change light emission luminance in at least a partial region of a region where the display unit displays the image;
a region acquisition unit configured to acquire data to identify an interest region in the image; and
a control unit configured to reduce a light emission luminance value of the light emission unit corresponding to a second region, which is an image region excluding a first region that includes at least the interest region.

2. The image display apparatus according to claim 1, further comprising:
an image correction unit configured to reduce a pixel value of the image in a boundary region of the second region, which is located within a predetermined range from the first region.

3. The image display apparatus according to claim 2, wherein the image correction unit acquires a reduction amount of the pixel value, based on light emission characteristics of the display unit and the pixel value.

4. The image display apparatus according to claim 1, wherein the control unit changes the light emission luminance of a region corresponding to the second region in response to a change of information relating to pixels included in the interest region.

5. The image display apparatus according to claim 1, further comprising:
an image display control unit configured to control a display mode of the displayed image,
wherein the control unit restricts the control of the light emission luminance of a region corresponding to the second region by the image display control unit, if the display mode is a predetermined display mode.

6. The image display apparatus according to claim 5, wherein the control unit restricts the control of the light emission luminance of the region corresponding to the second region by the image display control unit, if the display mode permits a user to operate the image in the interest region.

7. The image display apparatus according to claim 1, wherein the light emission unit includes a plurality of light emission regions in which the light emission luminance is changeable, and
the control unit causes one of the plurality of light emission regions, in which a light emission influence region overlaps with the interest region, to emit light at a light emission luminance corresponding to an area where the interest region overlaps with the light emission influence region influenced by light emission of the one of the plurality of light emission regions.

8. The image display apparatus according to claim 1, further comprising:
a control region acquisition unit configured to determine the first and second regions based on the interest region.

9. The image display apparatus according to claim 1, wherein the image is a medical image and the interest region is a diagnosis target region included in the medical image.

10. The image display apparatus according to claim 1, wherein the region acquisition unit acquires the data to identify the interest region in the image from an external apparatus connected to the image display apparatus.

11. The image display apparatus according to claim 1, further comprising:
an operation unit configured to accept a user operation that designates the interest region in the image.

12. An image display method for causing a processor to perform processing, the method comprising:
acquiring data to identify an interest region in an image displayed by an image display unit configured to control light emission luminance;
acquiring a second region, which is an image region excluding a first region that includes at least the interest region; and
causing the image display unit to reduce the light emission luminance of a region corresponding to the second region.

13. The method according to claim 12, further comprising:
reducing a pixel value of the image in a boundary region of the second region, which is located within a predetermined range from the first region.

14. The method according to claim 12, further comprising:
determining the first and second regions based on the interest region.

15. The method according to claim 12, wherein the image is a medical image and the interest region is a diagnosis target region included in the medical image.

16. An image display control apparatus that controls a light emission unit configured to control light emission luminance in at least a partial region of a region where a display unit displays an image, comprising:
a region acquisition unit configured to acquire data to identify an interest region in the image; and
a control unit configured to reduce a luminance value of the light emission unit corresponding to a second region, which is an image region excluding a first region that includes at least the interest region.

17. A light emission luminance control program that causes a computer to realize:
a function of acquiring data to identify an interest region in an image displayed by an image display unit configured to control light emission luminance;
a function of acquiring a second region, which is an image region excluding a first region that includes at least the interest region; and
a function of causing the image display unit to reduce the light emission luminance of a region corresponding to the second region.

18. The control program according to claim 17, further comprising:
a function of reducing a pixel value of the image in a boundary region of the second region, which is located within a predetermined range from the first region.

19. The control program according to claim 17, further comprising:
a function of determining the first and second regions based on the interest region.

20. The control program according to claim 17, wherein the image is a medical image and the interest region is a diagnosis target region included in the medical image.
